(19) United States
(12) Patent Application Publication
(10) Pub. No.: US 2026/0105393 A1
(43) Pub. Date: Apr. 16, 2026

(54) SYSTEMS AND METHOD FOR MANAGING MACHINES

(71) Applicant: Caterpillar Inc., Peoria, IL (US)

(72) Inventors: Jeremie Lacasse, Quebec (CA); Carla Wesley, Keperra (AU)

(73) Assignee: Caterpillar Inc., Peoria, IL (US)

(21) Appl. No.: 18/915,468

(22) Filed: Oct. 15, 2024

(51) Int. Cl. G06Q 10/0631; H04W 4/029; H04W 4/40

(52) U.S. Cl. CPC G06Q 10/06316; G06Q 10/063114; H04W 4/029; H04W 4/40

(57) ABSTRACT

A system for managing machines is disclosed. The system receives inputs associated with work areas from monitoring devices and determines activity parameters associated with the work areas. The activity parameters include a time duration since completion of a first activity by first type of machines, and a count of completion of a second activity by second type of machines in each work area. The activity parameters may be assigned a predefined priority with respect to each other. The system is also configured to assign a priority for performing the first activity at each work area based on the determined activity parameters and the predefined priority. Further, the system is configured to rank the work areas based on the assigned priority and provide a list of the ranked work areas to electronic devices associated with the first type of machines.

### TECHNICAL FIELD

The present disclosure relates, in general, to coordinating machine activities at a work site. More particularly, the present disclosure related to systems and a method for managing machines and machine operations.

### BACKGROUND

Typically, different machines may be employed to perform different operations at a worksite. Oftentimes, the operations of some machines may be required to be managed based on the operations of other machines at the worksite. For example, water trucks may be required to water different work areas at the worksite periodically to control dust resulting from different operations including, but not limited to, mining and hauling, performed by other machines including, but not limited to, haul trucks at the worksite. The water trucks may also be employed at the work site for fire prevention and control at the different work areas.

However, at present, watering operations performed by the different water trucks at the different work areas are managed by machine operators of the water trucks. A machine operator of a water truck may often have limited information regarding the watering operations performed by other water trucks. Consequently, without coordination between the machine operators of different water trucks, one or more work areas may be over watered as result of repeated watering of the work areas by the different water trucks. Similarly, in some instances, one or more water trucks may arrive at a specific work area when another water truck is already stationed at and watering the specific work area. In addition, the watering operations of the water trucks may also be required to be coordinated with the hauling or mining operations performed by the haul trucks to control the dust generated as a result. Accordingly, without information regarding the haul trucks or the operations performed or being performed by the haul trucks, the machine operators of the water trucks may be unable to determine an appropriate time to water the different work areas. Therefore, such a lack of coordination between machines, machine operations, or machine operators may often result in unnecessary and unwanted time and production delays, water and resource wastage, and operational inefficiencies.

US Publication 2020/0150669, hereinafter referred to as “the '669 reference”, relates to an autonomous dust mitigation system for mining and construction applications. The dust mitigation system automatically detects dust at mining and construction sites and dispatches dust mitigation equipment in response to such detections. The dust areas detected may be assigned priorities within the dust mitigation system and may be addressed or ignored based on various parameters dictating the behavior of the dust mitigation system. If, for example, an area of dust is not currently in use by local equipment, the dust mitigation system may not dispatch equipment to address that area. If, on the other hand, an area of dust is affecting a high priority or high-risk area of the site, the dust mitigation system may prioritize the dispatching of dust mitigation equipment to that area over other areas. The dust mitigation system contains a plurality of sensors, a computing device, a dust area mapping system, a dust area prioritizing system, and a plurality of dust mitigation equipment.

However, the dust mitigation system of the '669 reference merely addresses the problem of identifying dust at different work areas and prioritizing specific work areas for dust mitigation. For example, the dust mitigation system of the '669 reference may identify the high-priority area for dust mitigation and deploy the dust mitigation equipment at the high-priority work area at a time when another machine such as a haul truck may be performing hauling operations at the high-priority area. Similarly, machine operators of the haul trucks may also be unaware of and arrive at high-priority area at a time when the dust mitigation equipment(s) is operating at the high-priority area. The dust mitigation system of the '669 reference does not take into consideration various activities performed by different machines and hence, does not address the problem of coordinating the activities of the machines. Hence, there is a need to improve coordination between the different machines, the machine operations, and the machine operators operating at the worksite.

### SUMMARY

A tracking system for managing machines is disclosed. The tracking system includes a transceiver in communication with at least one first type of machine and at least one second type of machine of the machines, and at least one electronic device associated with the first type of machine. The tracking system also includes a processor and a memory having, stored thereon, instructions that when executed by the processor, causes the processor to receive at least one input associated with work areas from at least one monitoring device. The processor is also configured to determine multiple activity parameters associated with the work areas based on the received input(s). The determined activity parameters include, but are not limited to, a time duration since completion of a first activity by the first type of machine in each work area of the multiple work areas. The determined activity parameters also include a count of completion of at least one second activity by the at least one second type of machine in each work area. Each determined activity parameter of the determined activity parameters is assigned a predefined priority with respect to each other. Further, the processor is configured to assign a priority for performing the first activity at each work area based on the determined activity parameters and the predefined priority. The processor is also configured to rank the plurality of work areas based on the assigned priority. In addition, the processor is configured to provide the ranked work areas as a list to the electronic device to initiate or stall the first activity or the first type of machine in a work area of the ranked work areas in the list.

A monitoring system for managing machines is disclosed. The monitoring system includes at least one electronic device associated with at least one first type of machine and a tracking system. The tracking system is configured to receive at least one input associated with different work areas from at least one monitoring device. The tracking system is also configured to determine multiple activity parameters associated with the work areas based on the received input(s). The determined activity parameters include, but are not limited to, a time duration since completion of a first activity by the first type of machine in each work area of the multiple work areas. The determined activity parameters also include a count of completion of at least one second activity by the at least one second type of machine in each work area. Each determined activity parameter of the determined activity parameters is assigned predefined priority with respect to each other. Further, the tracking system is configured to assign a priority for performing the first activity at each work area based on the determined activity parameters and the predefined priority. The tracking system is also configured to rank the plurality of work areas based on the assigned priority. In addition, the tracking system is configured to provide the ranked work areas as a list to the electronic device to initiate or stall the first activity or the first type of machine in a work area of the ranked work areas in the list.

A method for managing machines is disclosed. The method includes a step of receiving at least one input associated with different work areas from at least one monitoring device and determining multiple activity parameters associated with the work areas based on the received input(s). The determined activity parameters include, but are not limited to, a time duration since completion of a first activity by at least one first type of machine in each work area of the multiple work areas. The determined activity parameters also include a count of completion of at least one second activity by at least one second type of machine in each work area. Each determined activity parameter of the determined activity parameters is assigned predefined priority with respect to each other. Further, the method also includes a step of assigning a priority for performing the first activity at each work area based on the determined activity parameters and the predefined priority. The method also includes a step of ranking the plurality of work areas based on the assigned priority. In addition, the method includes the step of providing the ranked work areas as a list to the electronic device to initiate or stall the first activity or the first type of machine in a work area of the ranked work areas in the list.

### BRIEF DESCRIPTION OF DRAWINGS

FIG. 1 is an exemplary diagrammatic illustration of an environment for managing machines in accordance with which various embodiments of the preset disclosure are implemented;

FIG. 2 is a schematic block diagram of a tracking system for managing machines, in accordance with embodiments of the present disclosure;

FIG. 3 is an exemplary diagrammatic illustration of a list of ranked work areas provided in an electronic device, in accordance with the embodiments of the present disclosure; and

FIG. 4 is a flow chart of a method for managing machines, in accordance with the embodiments of the present disclosure.

### DETAILED DESCRIPTION

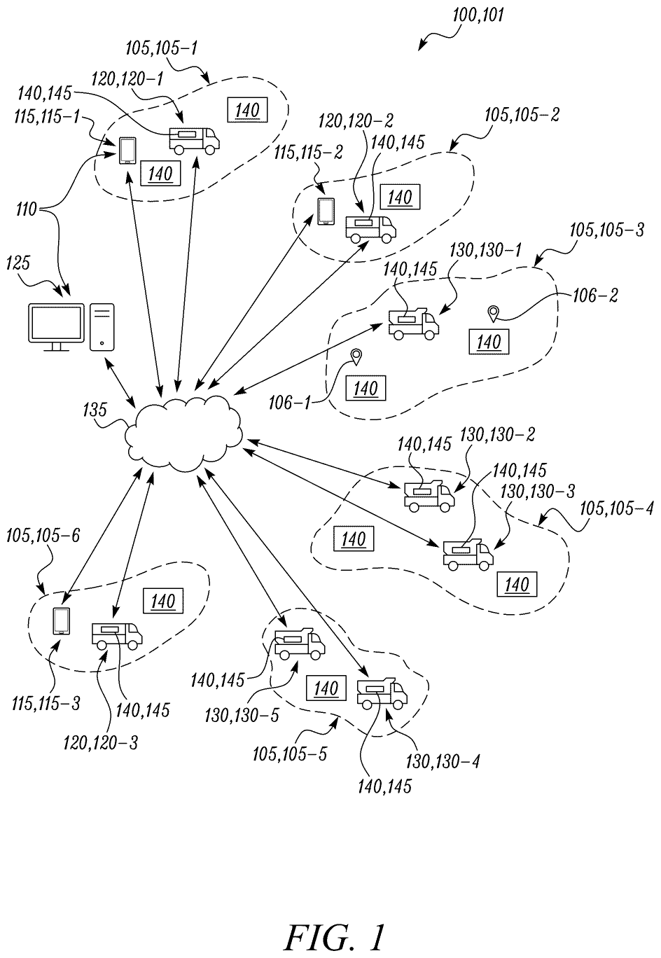

Referring FIG. 1, an environment 100 for managing machines is disclosed. The environment includes a worksite 101 comprising multiple work areas 105 and a monitoring system 110 for monitoring the work areas 105. The monitoring system 110 includes electronic devices 115 associated with first type of machines 120 respectively and a tracking system 125 in communication with the electronic devices 115, the first type of machines 120, and second type of machines 130 via a network 135. Examples of the tracking system 125 and the electronic devices 115 include, but are not limited to, computers, laptops, mobile devices, handheld devices, personal digital assistants (PDAs), tablet personal computers, digital notebook, automatic teller machines (ATMs), wearables, and other electronic devices known to persons skilled in the art for performing functions consistent with the present disclosure. In embodiments, the tracking system 125 may also be a physical server, a cloud server, or a combination of physical and/or cloud servers. Examples of the first type of machines 120 include, but are not limited to, water trucks. Examples of the second type of machines 130 include, but are not limited to, haul trucks. Examples of the network 135 include, but are not limited to, a Local Area Network (LAN), a Wireless Local Area Network (WLAN), a Small Area Network (SAN), a Wi-Fi Direct Network and a telecommunication network including, but not limited to, a fourth generation (4G) and a fifth generation (5G) cellular network.

The tracking system 125 is configured to receive at least one input associated with the work areas 105 from at least one monitoring device 140. The tracking system 125 may be configured to monitor the work areas 105 based on input(s) or information received from the monitoring devices 140 provided at the work areas 105 or sensing and/or transmitting devices 145 provided in the first type of machines 120 and the second type of machines 130 respectively. Examples of the monitoring devices 140 and/or or sensing and/or transmitting devices 145 include, but not limited to, cameras, motion sensors, heat sensors, devices with mapping systems, or satellite-based navigation systems. In embodiments, the tracking system 125 may also be configured to monitor the first type of machines 120 and/or the second type of machines 130 operating in the work areas 105. In embodiments, the first type of machines 120 and the second type of machines 130 may include the sensing and/or transmitting devices 145. The sensing and/or transmitting devices 145 may be configured to provide information related to one or more operating parameters or one or more operations performed by the first type of machines 120 and/or the second type of machines 130. Examples of the operating parameters include, but are not limited to, an amount of water, fuel, or battery stored in a storage, a speed, and a location of the first type of machines 120 and/or the second type of machines 130. Examples of the operations include, but are not limited to, watering operations, and hauling operations.

The tracking system 125 is also configured to determine multiple activity parameters associated with the monitored work areas 105 based on the received input(s) from the monitoring devices 140. The determined activity parameters include, but are not limited to, a time duration since completion of a first activity by one or more first type of machines 120 in each work area. The determined activity parameters also include a count of completion of at least one second activity by one or more second type of machines 130 in each work area. In embodiments, the determined activity parameters may also include a machine status of the first type of machines 120 and the second type of machines 130 currently or previously operating at each work area. In embodiments, the determined activity parameters may also include planned work areas 105-1 among the work areas 105 assigned to or identified corresponding to the first type of machines 120 respectively. Each determined activity parameter of the determined activity parameters is assigned a predefined priority with respect to each other. In embodiments, the first activity and the second activity may be same or different from each other. In embodiments, the first type of machine and the second type of machine may be same or different from each other. In embodiments, the first type of machines 120 may correspond to water trucks and the first activity may correspond to watering operations performed by the water trucks at the work areas 105. Similarly, the second type of machines 130 may correspond to haul trucks and the second activity may correspond to hauling operations performed by the haul trucks at the work areas 105.

The tracking system 125 may also be configured to assign a priority for performing the first activity at each work area based on the determined activity parameters and the predefined priority. The tracking system 125 is also configured to rank the work areas 105 based on the assigned priority. In addition, the tracking system 125 is configured to provide the ranked work areas 105 as a list to the electronic devices 115 associated with the first type of machines 120 respectively to initiate or stall the first activity or the first type of machines 125 in at least one work area of the ranked work areas 105 in the list. In embodiments, the electronic devices 115 may be provided in the first type of machines 120 or may be independent from the first type of machines 120. In embodiments, the electronic devices 115 may be associated with operators of the first type of machines 120 respectively. The electronic devices 115 may be configured to display the list of the ranked work areas 105. In embodiments, the electronic devices 115 may also be configured to display at least one activity parameter of the determined activity parameters corresponding to each work area in the list. In embodiments, one or more electronic devices, for example, 115-1, 115-2 may be configured to receive a selection corresponding to one or more work areas, for example, 105-1, 105-2, displayed in the list from one or more first type of machines, for example, 120-1, 120-2. In embodiments, the electronic devices, for example, 115-1, 115-2 may be configured to provide the selected work area as the planned work area identified corresponding to the first type of machines, for example, 120-1, 120-2, to the tracking system 125.

In embodiments, the tracking system 125 may be configured to receive the selected work areas, for example, 105-1, 105-2, from the electronic devices, for example, 115-1, 115-2, associated with the first type of machines, for example, 120-1, 120-2. In embodiments, the tracking system 125 may also be configured to identify the selected work areas, for example, 105-1, 105-2, as the planned work area corresponding to the first type of machines, for example, 120-1, 120-2. In embodiments, the tracking system 125 may also be configured to determine an overlap between the planned work areas, for example, 105-1, 105-2, identified corresponding to the first type of machines, for example, 120-1, 120-2, respectively. For instances when the tracking system 125 determines the overlap, the tracking system 125 may be configured to provide feedback indicating the overlap to one or more conflicting electronic devices, for example, 115-1, 115-2. For instances when the planned work areas, for example, 105-1, 105-2, are distinct, the tracking system 125 is configured to provide an updated list of the ranked work areas 105 to the electronic devices 115 simultaneously. The updated list may include updated planned work areas, for example, 105-1, 105-2, identified corresponding to the non-conflicting electronic devices, for example, 115-1, 115-2, associated with the first type of machines, for example, 120-1, 120-2, respectively. The list or the updated list of ranked work areas and/or the determined operating parameters provided in the list may enable an operator of the electronic device, for example, 115-3, associated with the first type of machine, for example, 120-3, to initiate or perform the first activity at a work area, for example, 105-3 of the ranked work areas 105 or stall the first type of machine, for example, 120-3, from performing the first activity in a work area, for example, 105-2, identified as the planned work area corresponding to the first type of machine, for example, 120-2, in the list.

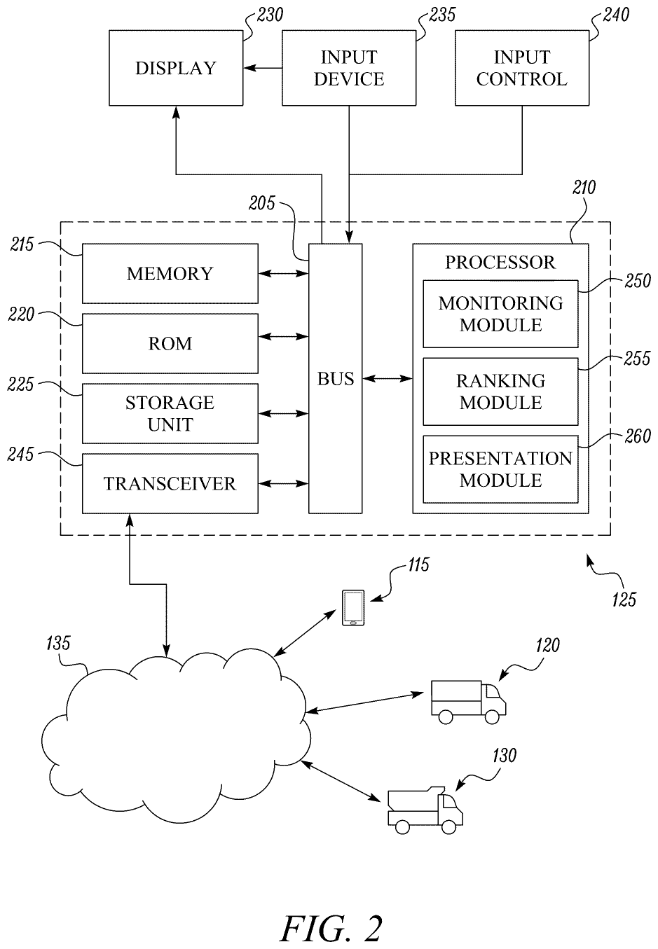

Referring to FIG. 2, a schematic illustration of the tracking system 125 of FIG. 1 is disclosed. The tracking system 125 includes a bus 205 or other communication mechanism for communicating information, and a processor 210 coupled with the bus 205 for processing information. The tracking system 125 also includes a memory 215, such as a random-access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The tracking system 125 further includes a read only memory (ROM) 220 or other static storage device coupled to bus 205 for storing static information and instructions for the processor 210.

A storage unit 225, such as a magnetic disk or optical disk, is provided and coupled to the bus 205. The storage unit 225 may store information corresponding to the electronic devices 115, the first type of machines 120, and the second type of machines 130. The information may include, but is not limited to, a type of each machine, a utility associated with each machine, a current location of each machine, one or more operations to be performed by each machine, the operations completed by each machine, a machine identification associated with each machine, an operator assigned to each machine or each electronic device, device identification associated with each electronic device, operator identification, a map of the worksite 101 (see FIG. 1), location of the work areas 105 (see FIG. 1) in the worksite 101 and on the map, a count of the work areas 105, and a count of the machines 120, 130 operating in each work area. The storage unit 225 may also store one or more activity parameters associated with the work areas 105 and a predefined priority assigned to the activity parameters. The activity parameters may include, but are not limited to, a machine status of each machine currently or previously operating in each work area, a count of completion of each operation by each machine in each work area, a time duration since completion of the operations by each machine in each work area, one or more planned work areas identified or assigned corresponding to each machine for performing the operations. In embodiments, the storage unit 225 may also store one or more machine learning, artificial intelligence, logical, and/or conditional modules, algorithms, and/or models. It may be understood that the information stored in the storage unit 225 may be accessed by the processor 210 via the memory 215 to perform one or more functions.

The tracking system 125 can be coupled via the bus 205 to a display 230, such as a light emitting diode (LED) and a liquid crystal display (LCD) for displaying information to a controller, such as a supervisor. An input device 235 is coupled to bus 205 for communicating information and command selections to the processor 210. The input device 235 may be included in the display 230, for example a touch screen that facilitates detection of multi-touch inputs from the user via the display 230. The input device 235 may also correspond to peripheral input devices that may be paired with the tracking system 125 via Bluetooth, Wi-Fi, Wi-Fi direct, or as a hardware connection such a USB peripheral to the tracking system 125. Examples of the peripheral input devices include, but are not limited to, a joystick, a gamepad, a keyboard, a mouse, a gesture-controlled device, or a wearable device such as, for example, a smart watch. In embodiments, the input device 235 may also correspond to a microphone (not shown) provided in the tracking system 125 that is configured to received audio inputs or instructions from one or more work supervisors. In embodiments, the input device 235 may also include alphanumeric and other keys. Another type of user input device is an input control 240, such as a mouse, a trackball, or cursor direction keys for communicating direction information and command selections to the processor 210 and for controlling cursor movement on the display 230.

Various embodiments are related to the use of tracking system 125 for implementing the techniques described herein. In one embodiment, the techniques are performed by the tracking system 125 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the tracking system 125, various machine-readable medium is involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine. Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that include the bus 205. Transmission media can also take the form of acoustic or light waves, such as those generated during radio-wave and infra-red data communications. Examples of machine-readable medium may include, but are not limited, to a carrier wave as described hereinafter or any other medium from which the tracking system 125 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the tracking system 125 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored in the storage unit 225 either before or after execution by the processor 210.

The tracking system 125 also includes a transceiver 245 coupled to the bus 205. The transceiver 245 provides a two-way data communication coupling with the electronic devices 115 and the machines 120, 130. For example, the transceiver 245 can be an integrated service digital network (ISDN) card or a modem to provide a data communication connection to a corresponding type of telephone line. As another example, the transceiver 245 can be a local area network (LAN) card to provide a data communication connection to a compatible LAN. Wireless links can also be implemented. In any such implementation, the transceiver 245 sends and receives radio, electrical, electromagnetic, or optical signals that carry digital data streams representing various types of information.

In embodiments, the processor 210 may be capable of executing the computer instructions stored in the memory 215 to perform one or more functions. In embodiments, the processor 210 may include one or more modules 250-265 to perform the one or more functions. For example, the processor 210 may include a monitoring module 250, a ranking module 255, and a presentation module 260. It may be understood that the modules 250-260 may correspond to and/or include hardware and/or software components respectively and may be configured to perform respective functions. It may also be understood that, in embodiments, the modules 250-260 may implement one or more machine learning, artificial intelligence, logical, and/or conditional operations, modules, algorithms, and/or models stored in the storage unit 225 to perform respective functions.

The monitoring module 250 may be configured to monitor the work areas 105 (see FIG. 1) based on remote sensing of the work areas 105. In embodiments, monitoring module 250 may be configured to receive inputs or information including, but not limited to, images, sensor inputs, and/or location information including, but not limited to, Global Positioning System (GPS) coordinates, from the monitoring devices 140 (see FIG. 1) provided at the work areas 105. In embodiments, the monitoring devices 140 including, but not limited to, devices with mapping systems or satellite-based navigation systems may also be provided in the tracking system 125. In embodiments, the monitoring module 250 may be configured to receive information corresponding to the work areas 105 via the mapping or navigation systems. In embodiments, the monitoring devices 140 may include the sensing and/or transmitting devices 145 (see FIG. 1) provided in the machines 120, 130. In embodiments, the monitoring module 250 may also be configured to monitor the first type of machines 120 and/or the second type of machines 130 operating in the work areas 105 via the sensing and/or transmitting devices 145 provided in the first type of machines 120 and/or the second type of machines 130.

In embodiments, the monitoring module 250 may also be configured to receive information related to the operating parameters or operations performed by the first type of machines 120 and/or the second type of machines 130 via the sensing and/or transmitting devices 145. In embodiments, monitoring module 250 may be configured to determine operating parameters including, but not limited to, an amount of water, fuel, or battery stored in a storage, a speed, a location, a count of the first type of machines 120 and/or the second type of machines 130 operating at each work area, and a timestamp of completion of the first activity by the first type of machines 120. In embodiments, the monitoring module 250 may receive location information including, but not limited to, GPS coordinates, associated with the first type of machines 120 and the second type of machines 130. In embodiments, the monitoring module 250 may be configured to monitor the work areas 105 by correlating the location information associated with the machines 120, 130 received from the sensing and/or transmitting devices 145 provided in the machines 120, 130 and the location information received via the other monitoring devices 140 provided in the work areas 105. In embodiments, the monitoring module 250 may be configured to determine operations including, but not limited to, watering operations and hauling operations performed by the first type of machines 120 and/or the second type of machines 130.

Referring to FIGS. 1-2, in embodiments, the monitoring module 250 may be configured to determine activity parameters associated with the monitored areas and/or the monitored machines 120, 130 based on the received input(s) or information from the monitoring devices 140. In embodiments, the monitoring module 250 may be configured to determine activity parameters based on the images, the sensor inputs, the location information, the operating parameters and/or the operations determined. The determined activity parameters may include, but are not limited to, a time duration since completion of a first activity by one or more first type of machines, for example, 120-1, 120-2, in each work area, for example 105-1, and a count of completion of a second activity by one or more second type of machines, for example, 130-1, 130-2, in each work area. In embodiments, the determined activity parameters may also include a machine status of the first type of machines 120 and the second type of machines 130 currently or previously operating at each work area, and one or more planned work areas of the work areas 105 assigned to or identified corresponding to the first type of machines 120 respectively.

In embodiments, the monitoring module 250 may be configured to determine the time duration since completion the first activity based on a last recorded timestamp of completion of the first activity by the first type of machine, for example, 120-1, last detected at the work area, for example, 105-1, via the monitoring devices 140. In embodiments, the monitoring module 250 may be configured to determine the timestamp of completion of the first activity in the work area, for example, 105-1 based on, but not limited to, the current location of the first type of machine, for example, 120-1, a detection of stoppage of the first activity via sensing and/or transmitting devices 145 provided in the first type of machine, an input received via the electronic device, for example, 115-1, associated with the first type of machine. The monitoring module 250 may be configured to determine the time duration based on a time period determined between a current time and the previously determined timestamp. As an example, the monitoring module 250 may be configured to determine the time duration since the completion of the watering operations by the last detected water truck, for example, the first type of machine 120-1 at the work area 105-1. For instances when the monitoring module 250 may determine the time duration to be equal to nil, the monitoring module 250 may determine that the first activity is currently being performed by the first type of machine, for example, 120-1, at the work area, for example, 105-1 associated with the determined time duration.

The monitoring module 250 may be configured to determine the count of completion of the second activity by the second type of machines, for example, 130-1, 130-2, in each work area, for example, 105-2 based on, but not limited to, a timestamp of completion of the second activity by the second type of machines at each work area and a detection of the second type of machines at each work area via the monitoring devices 140 and/or the sensing and/or transmitting devices 145. In embodiments, each work area, for example, 105-3, may include one or more operating zones for example, 106-1 and 106-2, that may together define a production circuit or route. In embodiments, each work area, for example, 105-3, may correspond to the production circuit or route. Each production circuit may include a combination, or a group of the operating zones, for example, 106-1, 106-2, assigned to one or more machines, for example, the second type of machine 130-1 to move to and perform operations sequentially or selectively. In embodiments, a first and a last operating zone of the combination or group of operating zones in each production circuit may be same or different. A completion of operations from the first operating zone to the last operating zone in the production circuit may correspond to a completion of the production circuit by each machine. In embodiments, the completion of the second activity may correspond to the completion of the production circuit and the count of completion of the second activity may correspond to a count of the completion of the production circuit. It may be understood that, in order to determine the count of completion of the second activity by the second type of machines 130 in each work area, the monitoring module 250 may be configured to detect the second type of machines, for example, 130-1, 130-2, at each operating zone, for example, 106-1, of the work area, for example, 105-3, via the monitoring devices 140 provided at the operating zones, for example, 106-1, 106-2, or via or the sensing and/or transmitting devices 145 provided in the second type of machines, for example, 130-1, 130-2.

As an example, the second type of machines, for example, 130-1, 130-2 may be assigned to perform hauling operations at a first production circuit including the operating zones, for example, 106-1, 106-2, in the work area, for example, 105-3. In particular, the second type of machines 130-1, 130-2 may be assigned to haul material from the operating zone 106-1 and unload the hauled material at the operating zone 106-2. A completion of the hauling operation by the second type of machines 130-1, 130-2 from the first operating zone 106-1 to the last operating zone 106-2 corresponds to the completion of the production circuit or a haul cycle in the work area 105-3 once by the second type of machines 130-1, 130-2 respectively. Multiple completions of the production circuit correspond to a total count of haul cycles performed by the second type of machines 130-1, 130-2 in the work area 105-3.

The monitoring module 250 may be configured to determine the machine status of the first type of machines 120 and the second type of machines 130 currently or previously operating at each work area. In embodiments, the machine status may include, but is not limited to, a detection of the first type of machines 120 and the second type of machines 130 currently operating in each work area, a count of the detected first type of machines 120 and/or the second type of machines 130 currently or previously operating at each work area, and a timestamp of completion of the first activity or the second activity by the detected first type of machines 120 and/or the second type of machines 130 in each work area. For example, the monitoring module 250 may be configured to determine the machines status of a water truck corresponding to the first type of machine 120-1. The monitoring module 250 may be configured to determine the location of the water truck. The determined location may correspond to the work area, for example, 105-1. The monitoring module 250 may be also configured to determine a water dispensing operation performed by the water truck based on input(s) received from the sensing and/or transmitting devices 145 provided in the water truck. In embodiments, the monitoring module 250 may be configured to determine the dispensing of water from the water truck by monitoring an amount or a level of water stored in a water tank of the water truck periodically or in real-time. Accordingly, the monitoring module 250 may determine that the water truck, for example, the first type of machine 120-1, is currently dispensing water at the work area 105-1. Similarly, the monitoring module 250 may be configured to determine the machines status of a haul truck corresponding to the second type of machine 130-1. The monitoring module 250 may be configured to determine the location of the haul truck. The determined location may correspond to the work area, for example, 105-2. Further, the monitoring module 250 may be configured to determine that the haul truck is hauling material at the determined location, i.e., the work area 105-2 based on inputs received from the sensing and/or transmitting devices 145, for example, a load sensor provided in the haul truck. Accordingly, the monitoring module 250 may determine that the haul truck, for example, the second type of machine 130-1, is currently performing hauling operations at the work area 105-2. In embodiments, the monitoring module 250 may also be configured to receive the machine status of the first type of machines 120 and/or the second type of machines 130 via the electronic devices 115 associated with the machines 120, 130. In embodiments, the monitoring module 250 may be configured to compare the machine status received via the electronic device, for example, 115-1, associated with first type of machine, for example, 120-1 and the machine status received via the sensing and/or transmitting device 145 of the first type of machine in order to validate the machine status corresponding to the first type of machine.

In embodiments, the monitoring module 250 may be configured to determine the planned work areas of the work areas 105 assigned corresponding to the first type of machines 120 respectively via an assignment module (not shown) of the processor 210. In embodiments, the monitoring module 250 may also be configured to determine one or more work areas excluded from the determined planned work areas. In embodiments, the monitoring module 250 may be configured to determine the planned work areas, for example, 105-1, 105-2 identified corresponding to the first type of machines, for example, 120-1, 120-2, via an input received from the electronic devices, for example, 115-1, 115-2, associated with the first type of machines, for example, 120-1, 120-2, respectively. The planned work areas may correspond to identified work areas of the work areas 105 for performing the first activity by the first type of machines 120 in future and/or after completion of the first activity by the first type of machines 120 operating in respective work areas. For example, the first type of machine 120-1 corresponding to the water truck may be performing watering operations at the work area 105-1. The monitoring module 250 may be configured to determine that the work area 105-2 is assigned to or identified corresponding to the first type of machine 120-1 as the planned work area for performing the watering operations by the first type of machine 120-1 after completion of the watering operations by the first type of machine 120-1 at the work area 105-1. For instances when the monitoring module 250 may determine that the determined planned work area corresponding to one or more work areas is equal to nil, the monitoring module 250 may determine that the work areas are excluded from the determined planned work areas and that one or more first type of machines, for example, 120-1, may be required to be initiated to perform the first activity in the work areas excluded from the determined planned work areas.

In embodiments, the ranking module 260 may be configured to determine the predefined priority assigned to each activity parameter of the determined activity parameters. In embodiments, the predefined priority assigned to the count of completion of the second activity may be greater than the predefined priority assigned to the time duration since completion of the first activity. As an example, the predefined priority assigned to the count of the haul cycles performed by the second type of machines 130 in the work area, for example, 105-1, may be greater than the predefined priority assigned to the time duration since the completion of the watering operations by the first type of machine, for example, 120-1 at the work area, for example, 105-1. As another example, the predefined priority assigned to the planned work area, for example, 105-1, assigned or identified corresponding to the first type of machines 120 may be less than the predefined priority assigned to the time duration, the count of the haul cycles, or the machine status. In yet another example, the predefined priority assigned to work areas excluded from the determined planned work areas may be greater than the predefined priority assigned to the determined planned work areas assigned or identified corresponding to the first type of machines 120.

In embodiments, the ranking module 260 may be configured to assign a priority for performing the first activity at each work area based on the determined activity parameters by the monitoring module 250 and the predefined priority assigned to the determined activity parameters. In embodiments, the ranking module 260 may be configured to assign the priority based on a descending order of one or more determined activity parameters. In embodiments, the ranking module 260 may also be configured to compare the determined activity parameters corresponding to each work area and assign the priority to each work area based on the comparison. In addition, the ranking module 260 may be configured to rank the work areas 105 based on the assigned priority.

In an example, the first activity may correspond to watering operations and the second activity may correspond to hauling operations performed in the work areas 105-1, 105-2, 105-3, 105-4, 105-5, and 105-6. The first type of machines 120-1, 120-2 120-3 operating in the work areas 105-1, 105-2, 105-3, 105-4, 105-5, and 105-6 may correspond to the water trucks 120-1, 120-2 120-3. The second type of machines 130-1, 130-2, 130-3 operating in the work areas 105-1, 105-2, 105-3, 105-4, 105-5, and 105-6 may correspond to the haul trucks 130-1, 130-2, 130-3. The monitoring module 250 may determine the activity parameters corresponding to the work areas 105-1, 105-2, 105-3, 105-4, 105-5, and 105-6 as provided in Table 1 below:

TABLE 1

| | | | | Planned |
|---|---|---|---|---|
| | | Count of | | work area |
| Work Area | Time since | completion | Machine | assigned |
| or | last | of hauling | Status of | to first |
| Production | watering | operations | Water and | type of |
| Circuit | operation | (Haul cycles) | Haul Trucks | machine |
| 105-1 | 6 hours | 3 | W-0 H-3 | No |
| 105-2 | 3 hours | 7 | W-0 H-1 | No |
| 105-3 | 4 hours | 4 | W-0 H-2 | Yes, 120-1 |
| 105-4 | — | 4 | W-1 H-0 | Yes, 120-2 |
| 105-5 | 5 hours | 3 | W-0 H-1 | No |
| 105-6 | 2 hours | 1 | W-0 H-2 | Yes, 120-3 |

W - Count of Water Trucks, H - Count of Haul Trucks

Referring to Table 1 as shown above, the ranking module 255 may be configured to compare the determined activity parameters corresponding to the work areas 105-1, 105-2, 105-3, 105-4, 105-5, and 105-6. The ranking module 255 may determine that the time duration of 6 hours from completion of watering operations in work area 105-1 is greater than the time duration of 3 hours from the completion of watering operations in work area 105-2. The ranking module 255 may also determine that the count of completion of hauling operations or haul cycles in the work area 105-1 is equal to 3 and the count of completion of hauling operations or haul cycles in the work area 105-2 is equal to 7. The ranking module 255 may also determine that the predefined priority assigned to the count of haul cycles is greater than the determined time duration since completion of watering operations. Accordingly, while the determined time duration of 6 hours corresponding to the work area 105-1 is greater than the determined time duration of 3 hours corresponding to the work area 105-2, the ranking module 255 may assign a higher priority for performing the watering operations at the work area 105-2 since the count of haul cycles of 7 in the work area 105-2 is greater than the count of haul cycles of 3 in the work area 105-1. Similarly, while the count of haul cycles of 3 corresponding to the work area 105-1 and 105-5 is the same, the ranking module 255 may assign a higher priority for performing the watering operations at the work area 105-1 since the determined time duration of 6 hours in the work area 105-1 is greater than the determined time duration of 5 hours in the work area 105-5. Similarly, the ranking module 255 may assign a higher priority for performing the watering operations at the work area 105-5 in comparison to the work areas 105-3, 105-4 and 105-6.

The ranking module 255 may then configured to rank the work areas 105-1, 105-2, 105-3, 105-4, 105-5 and 105-6 based on determined activity parameters and the assigned priority as shown in Table 2 below:

TABLE 2

| | | | | | Planned |
|---|---|---|---|---|---|
| | | | Count of | | work area |
| | Work Area | Time since | completion | Machine | assigned |
| | or | last | of hauling | Status of | to first |
| | Production | watering | operations | Water Haul | type of |
| Rank | Circuit | operation | (Haul cycles) | Trucks | machine |
| 1 | 105-2 | 3 hours | 7 | W-0 H-1 | No |
| 2 | 105-1 | 6 hours | 3 | W-0 H-3 | No |
| 3 | 105-5 | 5 hours | 3 | W-0 H-1 | No |
| 4 | 105-3 | 4 hours | 4 | W-0 H-2 | Yes, 120-1 |
| 5 | 105-6 | 2 hours | 1 | W-0 H-2 | Yes, 120-3 |
| 6 | 105-4 | — | 4 | W-1 H-0 | Yes, 120-2 |

W - Count of Water Trucks, H, Count of Haul Trucks

In embodiments, the monitoring module 250 may be configured to identify a change in the determined activity parameters. For example, the monitoring module 250 may determine that the work area 105-1 has been assigned or identified as the planned work area corresponding to the first type of machine 120-1 via the assignment module (not shown) or the electronic device 115-1 associated with the first type of machine 120-1. The ranking module 255 may determine that the predefined priority assigned to the work areas excluded from the determined planned work areas is greater than the determined planned work areas. Accordingly, while the time duration of 6 hours determined corresponding to the work area 105-1 is greater than the time duration of 5 hours determined corresponding to the work area 105-5, the ranking module 255 may assign a greater priority to the work area 105-5 excluded from the planned work areas and thereby, modify the priority assigned corresponding to the work areas 105-1 and 105-5. The ranking module 255 may then modify the ranking based on the changes identified and the modified priorities assigned to the work areas as shown in Table 3 below:

TABLE 3

| | | | | | Planned |
|---|---|---|---|---|---|
| | | | | Machine | work area |
| | | | | Status of | assigned |
| | Work Area or | Time since | | Water and | to first |
| | Production | last watering | Count of | Haul | type of |
| Rank | Circuit | operation | Haul cycles | Trucks | machine |
| 1 | 105-2 | 3 hours | 7 | W-0 H-1 | No |
| 2 | 105-5 | 5 hours | 3 | W-0 H-1 | No |
| 3 | 105-1 | 6 hours | 3 | W-0 H-3 | Yes, 120-1 |
| 4 | 105-3 | 4 hours | 4 | W-0 H-2 | Yes, 120-1 |
| 5 | 105-6 | 2 hours | 1 | W-0 H-2 | Yes, 120-3 |
| 6 | 105-4 | — | 4 | W-1 H-0 | Yes, 120-2 |

W - Count of Water Trucks, H, Count of Haul Trucks

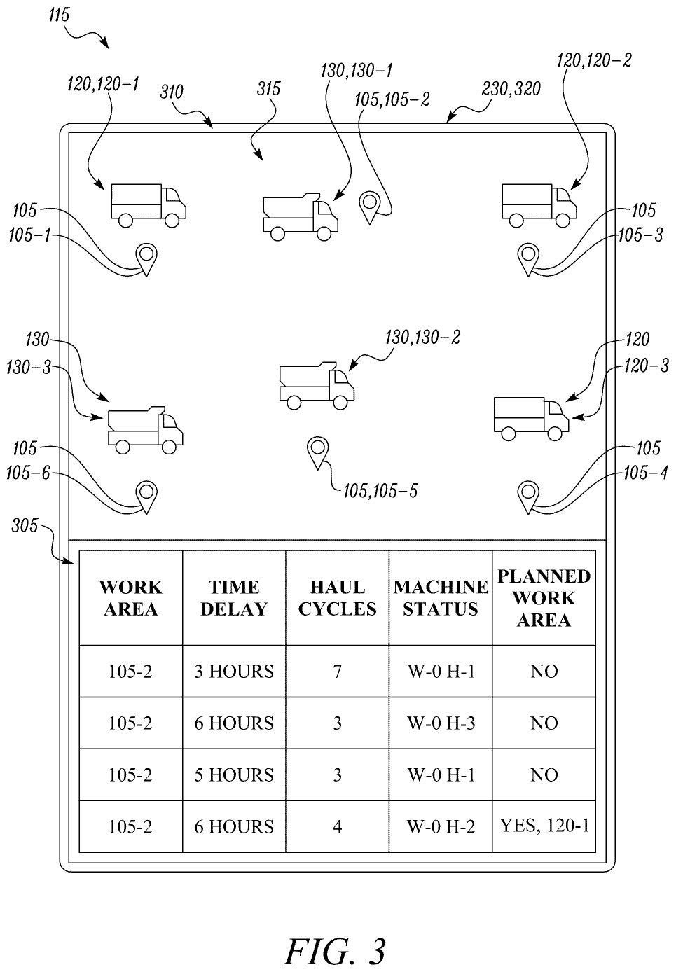

Referring to FIG. 3, the presentation module 265 (see FIG. 2) is configured to provide a list 305 of the ranked work areas 105 to the electronic devices 115 associated with the first type of machines 120 respectively to initiate or stall the first activity or one or more first type of machines from performing the first activity in one or more work areas of the ranked work areas 105 provided in the list 305. In embodiments, the electronic devices 115 may be configured to display the list 205 similar to the Table 2 outlined above in the present disclosure. It may be understood that each electronic device 115 may include components similar to the tracking system 125 of FIG. 2. For example, each electronic device 115 may include the bus 205, the processor 210, the memory, 215, the ROM 220, the storage unit 225, the display 230, the input device 235, the input controller 240, and the transceiver 245. The display 230 of the electronic device is herein referred to as the display 230, 320. It may also be understood that the processor 210 of each electronic device 115 may be configured to display the list 305 of ranked work areas 105 via a graphical user interface (GUI) 310 provided on the display 230, 320 of each electronic device 115. In embodiments, the presentation module 265 may be configured to provide at least one determined activity parameter of the multiple determined activity parameters corresponding to each work area in the list 305. In embodiments, the presentation module 265 may be also configured to provide one or more determined operating parameters associated with the first type of machines 120 by the monitoring module 255 to the electronic devices 115. Examples of the determined operating parameters provided to the electronic devices 115 include, but are not limited to, an amount of water, fuel, or battery in the storage of the first type of machine 120, and an amount of water dispensed from or infused into the first type of machines 120. In embodiments, the presentation module 265 may also be configured to provide a map 315 of the ranked work areas 105 to the electronic devices 115 respectively. The map 315 may include respective locations of the ranked work areas 105, respective locations of the first type of machines 120 and/or the second type of machines 130 currently operating in the work areas 105, and the planned work areas assigned to or identified corresponding to the of first type of machines 120 respectively.

In embodiments, the presentation module 265 may be configured to indicate the planned work areas differently from the remaining work areas in the list 305 and/or the map 315 provided to the electronic devices 115. In embodiments, the presentation module 260 may be configured to determine an overlap between the planned work areas assigned to or identified correspond to the first type of machines 120 respectively. In embodiments, the presentation module 260 may be configured to provide feedback to the electronic devices 115 respectively indicating the overlap. In embodiments, the presentation module 260 may cause the electronic devices 115 to indicate the feedback or overlap as an error, an alert, or a notification via the display 230, 320 of the electronic devices 115. In embodiments, the presentation module 260 may also be configured to indicate the overlap in the list 305 and/or the map 315.

In embodiments, the presentation module 260 may be configured to receive a request to sort the list 305 of the ranked work areas 105 based on at least one determined activity parameter via at least one electronic device 115, for example, 115-1. In embodiments, the presentation module 260 may be configured to receive the request to sort the list 305 of the ranked work areas 105 based on a descending order of the determined time duration or the determined count of completion of the second activity. In embodiments, the presentation module 260 may be configured to sort the list 305 of the ranked work areas 105 based on the request and provide the sorted list 305 of the ranked work areas 105 to the electronic device, for example 115-1, placing the request.

In embodiments, the presentation module 260 may also be configured to receive the machine status of the first type of machines 120 corresponding to the ranked work areas 105 provided in the list 305 or the map 315 via the electronic devices 115 associated with the first type of machines 120. In embodiments, the presentation module 260 may provide the received machine status to the monitoring module 255. The monitoring module 255 may be configured to compare the machine status received from the electronic devices 115 with the previously determined machine status. The monitoring module 255 may be configured to determine a match or a mismatch between the determined machine status and the received machine status. In embodiments, the presentation module 260 may be configured to provide feedback to the one or more electronic devices, for example 115-1, indicating the determined mismatch based on the comparison. For example, the presentation module 260 may receive the machine status of the first type of machine 120-1 via the electronic device 115-1 indicating that the first type of machine 120-1 has completed watering operations at the work area 105-1. The determined machine status by the monitoring module 255, via the monitoring devices 140, may indicate that the first type of machine 120-1 is currently dispensing the water at the work area 105-1. The monitoring module 255 may, accordingly, determine a mismatch between determined machine status and the received machine status from the presentation module 260. The presentation module 260 may then be configured to provide feedback indicating the determined mismatch to the electronic device 115-1 associated with the first type of machine 120-1.

In embodiments, the presentation module 260 may also be configured to receive the planned work areas corresponding to the first type of machines 120 from the electronic devices 115 via the displayed list 305 or the map 315 of ranked work areas 105. For example, the presentation module 260 may receive the planned work area, for example, 105-1, corresponding to the first type of machine 120-1 from the electronic device 115-1 associated with the first type of machine 120-1 via the displayed list 305 of the ranked work areas 105. The presentation module 260 may be configured to compare the received planned work areas from the electronic devices 115 after providing the list 305 with the determined planned work areas prior to providing the list 305. In embodiments, the presentation module 260 may be configured to determine an overlap between the determined planned work areas and the received planned work areas. In embodiments, the presentation module 260 may be configured to provide feedback to the electronic devices 115 respectively indicating the overlap. In embodiments, the presentation module 260 may cause the electronic devices 115 to indicate the feedback or overlap as an error, an alert, or a notification via the display 230, 320 of the electronic devices 115. In embodiments, the presentation module 260 may also be configured to indicate the overlap in the list 305 and/or the map 215.

In embodiments, the presentation module 260 may be configured to determine that the planned work area received corresponding to the first type of machine, for example, 120-1, from the electronic device, for example, 115-1, may correspond to the work area previously excluded from the determined planned work areas. The presentation module 260 may be configured to provide the updated planned work area corresponding the first type of machine, for example, 115-1, to the monitoring module 255. The monitoring module 255 may identify the change in the determined planned work area based the received planned work area corresponding to the first type of machine. As an example, the monitoring module 250 may determine that the work area 105-1 that was previously excluded from the determined planned work areas has been assigned or identified as the planned work area corresponding to the first type of machine 120-1 based on the received planned work area from the electronic device 115-1 associated with the first type of machine 120-1. Accordingly, the monitoring module 250 may update the determined planned work area corresponding to first type of machine, for example, 120-1, based on the received planned work area. The ranking module 255 may then be configured to modify the priority assigned corresponding to the work area, for example, 105-1, based on the updated planned work area. The ranking module 255 may then be configured to modify the ranking of the work areas 105 based on the changes identified and the modified priority assigned to the work area, for example, 105-1. The presentation module 260 may be configured to provide an updated list of the ranked work areas 105 based on the modified ranking to the electronic devices 115 associated with the first type of machines 120 respectively. As an example, the list 305 of ranked work areas 105 provided by the presentation module 260 to the electronic devices 115 may correspond to the Table 2 outlined above in the present disclosure and the updated list of the ranked work areas 105 provided by the presentation module 260 may correspond to the Table 3 outlined above in the present disclosure.

In embodiments, the list 305 or the updated list of ranked work areas 105 and/or the determined operating/activity parameters provided in the list 305 by the presentation module 260 may enable an operator of the electronic device, for example, 115-3, associated with the first type of machine, for example, 120-3 to indicate a work area, for example, 105-3 as the planned work area corresponding to the first type of machine, for example, 120-3. The operator may then proceed to initiate or perform the first activity at the work area, for example, 105-3 of the ranked work areas 105 after completion of the first activity in the current work area, for example, 105-1, of the first type of machine, for example, 120-3. In embodiments, the list 305 or the updated list of ranked work areas 105 and/or the determined operating/activity parameters provided in the list 305 by the presentation module 260 may also enable the operator to stall the first type of machine, for example, 120-3 from performing the first activity in a work area, for example, 105-2 identified as the planned work area corresponding to the first type of machine, for example, 120-2 in the list. Similarly, in embodiments, the list 305 or the updated list of ranked work areas 105 and/or the determined operating/activity parameters provided in the list 305 by the presentation module 260 may enable operators of other electronic devices, for example, 115-1, 115-2 associated with the first type of machines 120-1, 120-2 respectively to identify the work area, for example, 105-3 as the planned work area corresponding to the first type of machine, for example, 120-3 via the list 305 provided in the electronic devices, for example, 115-1, 115-2. Accordingly, the list 305 or the updated list of ranked work areas 105 provided by the presentation module 260 may stall the first type of machines 120-1, 120-2 from performing the first activity in the planned work area, for example, 105-3, identified corresponding to the first type of machine, for example, 120-3.

### INDUSTRIAL APPLICABILITY

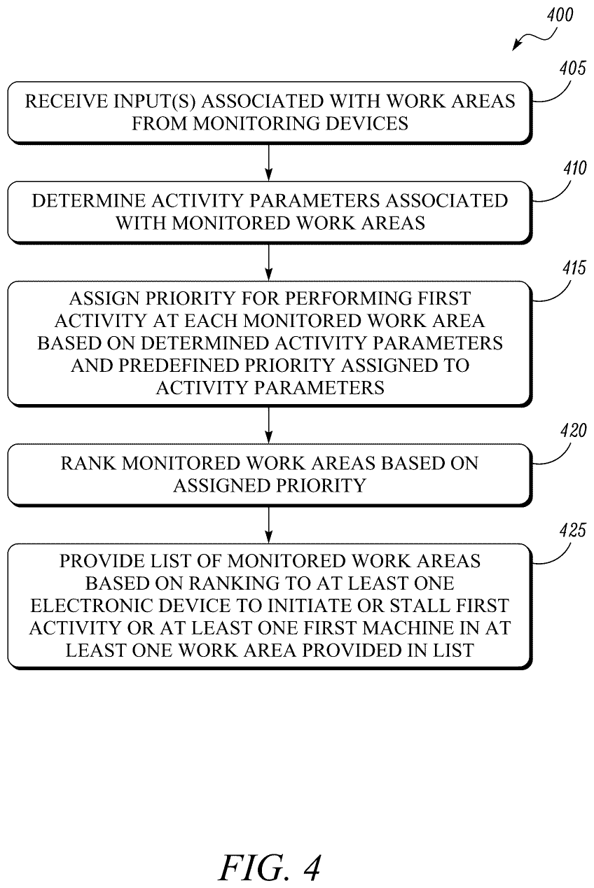

Referring to FIG. 4, a flowchart of a method 400 for managing machines 120, 130 of FIG. 1 is shown. At step 405, the method 400 includes receiving, via the monitoring devices 145 (see FIG. 1), at least one input associated with multiple work areas 105 (see FIG. 1) at the worksite 101 (see FIG. 1). At step 410, the method 400 also includes determining multiple activity parameters associated with the monitored work areas 105 based on the received input(s). The determined activity parameters include, but are not limited to, a time duration since a completion of a first activity by at least one first type of machine, for example, 120-1, in each work area of the multiple work areas 105. The determined activity parameters also include a count of completion of at least one second activity by at least one second type of machine, for example, 130-1, in each work area. In embodiments, the determined activity parameters may also include a machine status of the first type of machines 120 and the second type of machines 130 currently or previously operating at each work area. In embodiments, the determined activity parameters may also include a planned work area, for example, 105-1, from the work areas 105 assigned to or identified corresponding to the at least one first type of machine, for example, 120-1. Each determined activity parameter of the determined activity parameters is assigned a predefined priority with respect to each other. Further, at step 415, the method 400 includes assigning a priority for performing the first activity at each work area based on the determined activity parameters and the predefined priority. At step 420, the method 400 also includes ranking the work areas 105 based on the assigned priority. In addition, at step 425, the method 400 includes providing the ranked work areas 105 as the list 305 (see FIG. 3) to the electronic devices 115 associated with the first type of machines 120 respectively to initiate or stall the first activity or one or more first type of machines, for example, 120-1, from performing the first activity in one or more work areas of the ranked work areas 105 in the list 305.

It will be apparent that the systems 110, 125, and the method 400 of the present disclosure help operators of water trucks, corresponding to the first type of machines 120, keep track of activities performed by other water trucks at different work areas 105 of the worksite 101 at any given point of time. For example, the operator of the work truck, for example, 120-1 may consider performing watering operations at the work area, for example, 105-1, that is currently excluded from the determined planned work areas assigned or identified corresponding to other water trucks, for example, 120-2 and/or 120-3. The systems 110, 125 and the method 400 of the present disclosure may also help the operator consider performing watering operations at the work area, for example 105-2, having a greater time duration since the last recorded completion of the watering activity at the work area in comparison to the determined time duration associated with other work areas, for example, 105-1, 105-3, 105-4. Similarly, the systems 110, 125 and the method 400 of the present disclosure may also help the operator consider performing watering operations at the work area, for example 105-3, having a greater count of haul cycles or hauling operations at the work area in comparison to the determined count of haul cycles associated with other work areas, for example, 105-1, 105-2, 105-4. Further, the systems 110, 125 and the method 400 of the present disclosure may also help the operator of the first type of machine, for example, 120-1 to indicate to the operators of other first type of machines, for example, 120-2, 120-3 regarding a planned work area opted for by the operator corresponding to the first type of machine, for example, 120-1, for performing the watering operations in the planned work area. Thus, the systems 110, 125 and the method 400 of the present disclosure may help initiate the watering operations by one or more first type of machines, for example, 120-1, at the work area, for example, 105-1 having a higher priority than other work areas in the list 305 and stall other first type of machines, for example, 120-2, 120-3 from performing the watering operations at the work area, for example, 105-1 assigned to the first type of machine, for example, 120-1. The systems 110, 125 and the method 400 of the present disclosure may also help operators of the water trucks, for example, 120, determine status of hauling operations previously or currently being performed at each work area and accordingly, help determine an optimal time to perform the watering operations at each work area. As a result, it will be apparent that the systems 110, 125 and the method 400 of the present disclosure help prevent over-watering of the work areas 105, reduce water usage, avoid repetition of watering operations by different water trucks, for example, 120-1, 120-2 at the same work area, avoid an overlap between water trucks, for example, 120-1, 120-2, and/or avoid an overlap between the water trucks, for example, 120 and the haul trucks, for example, 130 at each work area. The systems 110, 125 and the method 400 of the present disclosure may also improve co-ordination between operators of the water trucks, for example, 120 and co-ordination of watering operations performed by the water trucks at the different work areas 105 and ensure timely and efficient watering operations at each work area, thereby improving the productivity.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A tracking system for managing machines, comprising:
a transceiver in communication with at least one first type of machine and at least one second type of machine of the machines, and at least one electronic device associated with the at least one first type of machine;
a processor; and
a memory having, stored thereon, instructions that when executed by the processor, causes the processor to:
receive at least one input associated with a plurality of work areas from at least one monitoring device;
determine a plurality of activity parameters associated with the plurality of work areas based on the at least one received input, the plurality of activity parameters comprising:
a time duration since completion of a first activity by the at least one first type of machine in each work area of the plurality of work areas, and
a count of completion of at least one second activity by the at least one second type of machine in each work area,
wherein a predefined priority is assigned to each activity parameter of the plurality of activity parameters;
assign a priority for performing the first activity at each work area based on the plurality of determined activity parameters and the predefined priority;
rank the plurality of work areas based on the assigned priority;
provide the plurality of ranked work areas as a list to the at least one electronic device to initiate or stall the first activity or the at least one first type of machine in at least one work area of the plurality of ranked work areas provided in the list.

2. The tracking system of claim 1, wherein the processor is configured to:
provide at least one determined activity parameter of the plurality of determined activity parameters corresponding to each work area in the list.

3. The tracking system of claim 1, wherein the processor is configured to:
assign the priority based on a descending order of at least one determined activity parameter of the plurality of determined activity parameters.

4. The tracking system of claim 1, wherein the predefined priority assigned to the count of completion of the at least one second activity is greater than the predefined priority assigned to the time duration since the completion of the first activity.

5. The tracking system of claim 1, wherein the at least one first activity and the at least one second activity are different, and the at least one first type of machine and the at least one second type of machine are different from each other.

6. The tracking system of claim 1, wherein the at least one first type of machine is a water truck configured for performing the first activity of watering the at least one work area and at least one second type of machine is a haul truck configured for performing the at least one second activity of hauling operations at the at least one work area.

7. The tracking system of claim 1, wherein the processor is configured to:
receive information from at least one transmitting device provided in the at least one first type of machine and the at least one second type of machine respectively; and
determine the plurality of activity parameters based on the information received from the at least one transmitting device.

8. The tracking system of claim 1, wherein the plurality of determined activity parameters comprises:
a machine status of the at least one first type of machine and the at least one second type of machine currently or previously operating at each work area; and
a planned work area from the plurality of work areas assigned or identified corresponding to the at least one first type of machine.

9. The tracking system of claim 8, wherein the processor is configured to:
receive the machine status via the at least one electronic device;
receive the machine status from at least one transmitting device provided in the at least one first type of machine;
compare the machine status received via the at least one electronic device and the machine status received via the at least one transmitting device; and
provide feedback to the at least one electronic device indicating a match, or an error based on the comparison.

10. The tracking system of claim 8, wherein the processor is configured to:
receive the planned work area identified corresponding to the at the one first type of machine via the at least one electronic device based on the list, prior to providing the list, or prior to and after providing the list to the at least one electronic device.

11. The tracking system of claim 8, wherein the at least one first type of machine corresponds to a plurality of first type of machines and at least one electronic device corresponds to a plurality of electronic devices associated with the plurality of first type of machines, and the processor is configured to:
determine an overlap between the planned work area assigned to or identified correspond to the plurality of first type of machines respectively; and
provide feedback to the plurality of electronic devices indicating the overlap.

12. The tracking system of claim 11, wherein the processor is configured to:
provide a map of the plurality of ranked work areas to the plurality of electronic devices, the map comprising a location of the plurality of first type of machines operating at corresponding work areas of the plurality of work areas, and the planned work area assigned to or identified corresponding to the plurality of first type of machines respectively.

13. The tracking system of claim 12, wherein the processor is configured to:
receive the planned work area identified corresponding to the at least one first type of machine via the map.

14. The tracking system of claim 1, wherein the processor is configured to:
receive a request to sort the list of the plurality of ranked work areas based on at least one activity parameter of the plurality of determined activity parameters via the at least one electronic device;
sort the list of the plurality of ranked work areas based on the request; and
provide the sorted list of the plurality of ranked work areas to the at least one electronic device.

15. The tracking system of claim 1, wherein the processor is configured to:
identify a change in at least one determined activity parameter of the plurality of determined activity parameters;
modify the assigned priority and the ranking based on the identification; and
provide a modified list of the plurality of ranked work areas based on the modified ranking.

16. The tracking system of claim 1, wherein the at least one electronic device is provided in the at least one first type of machine or is independent of the at least one first type of machine.

17. A monitoring system for managing machines, comprising:
at least one electronic device associated with at least one first type of machine of the machines; and
a tracking system in communication with the at least one electronic device, the tracking system configured to:
receive at least one input associated with a plurality of work areas from at least one monitoring device;
determine a plurality of activity parameters associated with the plurality of work areas based on the at least one received input, the plurality of activity parameters comprising:
a time duration since completion of a first activity by the at least one first type of machine in each work area of the plurality of work areas, and
a count of completion of at least one second activity by at least one second type of machine of the machines in each work area,
wherein a predefined priority is assigned to each activity parameter of the plurality of activity parameters;
assign a priority for performing the first activity at each work area based on the plurality of determined activity parameters and the predefined priority;
rank the plurality of work areas based on the assigned priority; and
provide the plurality of ranked work areas as a list based on the ranking to the at least one electronic device to initiate or stall the first activity or the at least one first type of machine in at least one work area of the plurality of ranked work areas provided in the list.

18. The monitoring system of claim 17, wherein the at least one electronic device is configured to:
display the list of plurality of ranked work areas and at least one activity parameter of the plurality of determined activity parameters corresponding to each work area in the list;
receive a selection corresponding to a work area of the plurality of ranked work areas displayed in the list; and
provide the selected work area as a planned work area identified corresponding to the at least one first type of machine to the tracking system.

19. The monitoring system of claim 18, wherein the at least one first type of machine corresponds to a plurality of first type of machines and at least one electronic device corresponds to a plurality of electronic devices associated with the plurality of first type of machines, and the tracking system is configured to:
provide the list of the plurality of ranked work areas to the plurality of electronic devices;
receive a selection corresponding to the plurality of ranked work areas displayed in the list from the plurality of electronic devices associated with the plurality of first type of machines;
identify the selected areas as the planned work area corresponding to the plurality of first type of machines respectively;
determine an overlap between the planned work area identified corresponding to the plurality of first type of machines respectively; and
provide feedback indicating the overlap to one or more conflicting electronic devices of the plurality of electronic devices based on the determined overlap corresponding to the one or more conflicting electronic devices or provide an updated list of the plurality of ranked work areas comprising an updated planned work area identified corresponding to one or more non-conflicting electronic devices of the plurality of electronic devices respectively based on the determined overlap corresponding to the one or more non-conflicting electronic devices.

20. A method for managing machines, comprising:
receiving at least one input associated with a plurality of work areas from at least one monitoring device;
determining a plurality of activity parameters associated with the plurality of work areas based on the at least one received input, the plurality of activity parameters comprising:
a time duration since completion of a first activity by at least one first type of machine of the machines in each work area of the plurality of work areas, and
a count of completion of at least one second activity by at least one second type of machine of the machines in each work area,
wherein a predefined priority is assigned to each activity parameter of the plurality of activity parameters,
assigning a priority for performing the first activity at each work area based on the plurality of determined activity parameters and the predefined priority;
ranking the plurality of work areas based on the assigned priority; and
providing the plurality of ranked work areas as a list based on the ranking to at least one electronic device associated with the at least one first type of machine to initiate or stall the first activity or the at least one first type of machine in at least one work area of the plurality of ranked work areas provided in the list.
